(19) United States
(12) Patent Application Publication
(10) Pub. No.: US 2026/0329857 A1
(43) Pub. Date: Oct. 22, 2026

(54) Information Processing System, Information Processing Method, and Non-Transitory Recording Medium

(71) Applicant: SoftBank Group Corp., Tokyo (JP)

(72) Inventor: Yuya Okawa, Tokyo (JP)

(21) Appl. No.: 19/653,514

(22) Filed: Apr. 21, 2026

(30) Foreign Application Priority Data
Apr. 22, 2025 (JP) 2025-070783

(51) Int. Cl. G06F 16/2453; G06F 16/3329

(52) U.S. Cl. CPC G06F 16/24532; G06F 16/33295

(57) ABSTRACT

Provided is an information processing system comprising a processor, wherein the processor executes a process of: causing a first agent to interpret a user request using a trained model; causing the first agent to autonomously execute parallel dialogues based on the user request with a plurality of second agents using an output of the trained model; and causing the first agent to aggregate information obtained through the dialogues with the second agents, and provide the aggregated information to the user using the output of the trained model.

### CROSS-REFERENCE TO RELATED APPLICATION

This application is based on and claims priority under 35 USC 119 from Japanese Patent Application No. 2025-070783 filed on Apr. 22, 2025, the disclosure of which is incorporated by reference herein.

### BACKGROUND

### Technical Field

The present disclosure relates to an information processing system, an information processing method, and a non-transitory recording medium.

### Related Art

Japanese Patent Application Laid-Open No. 2022-180282 discloses a persona chatbot control method executed by at least one processor, the method including: a step of receiving a user utterance; a step of adding the user utterance to a prompt including an instruction statement related to a description of a character of the chatbot; a step of encoding the prompt; and a step of inputting the encoded prompt to a language model to generate a chatbot utterance in response to the user utterance.

### SUMMARY OF THE INVENTION

In recent years, in order to respond to the diversifying needs of users, many unique AI agents and chatbots (hereinafter simply referred to as "agents") have been developed by companies and service providers. These agents provide functions such as responding to inquiries, providing information, and further supporting reservation procedures and purchasing by linking with companies' proprietary databases and APIs. However, in a situation in which numerous agents coexist in a fragmented manner, there is a problem that when a user attempts to use multiple services cross-sectionally, the user must interact with each agent individually, resulting in cumbersome tasks such as repeatedly explaining the same request, or logging in and inputting information for each service. Furthermore, in order to link multiple agents with each other, there is an issue that a means for uniformly and safely realizing the utilization range and privacy management of data held by each agent has not been sufficiently established, making it difficult to proceed with linkage between systems independently constructed by each company.

The present disclosure has been made in view of the above points, and an object thereof is to provide an information processing system, an information processing method, and a non-transitory recording medium that efficiently provide a user with information provided from a plurality of agents as compared with a case where the user individually makes inquiries to the agents.

An information processing system according to a first aspect of the present disclosure includes a processor, and the processor executes a process of: causing a first agent to interpret a user request using a trained model; causing the first agent to autonomously execute parallel dialogues based on the user request with a plurality of second agents using an output of the trained model; and causing the first agent to aggregate information obtained through the dialogues with the second agents, and provide the aggregated information to the user using the output of the trained model.

An information processing system according to a second aspect of the present disclosure is the information processing system according to the first aspect, wherein the processor causes the first agent to enable sharing of the user's data among the second agents based on the user's consent.

An information processing system according to a third aspect of the present disclosure is the information processing system according to the first aspect, wherein the processor causes the first agent to provide information to the user using the output of the trained model at a timing when new information is provided from the second agents.

An information processing system according to a fourth aspect of the present disclosure is the information processing system according to the first aspect, wherein the processor causes a third agent to evaluate answers of the second agents using the output of the trained model.

An information processing system according to a fifth aspect of the present disclosure is the information processing system according to the fourth aspect, wherein the processor causes the first agent to select the second agent to interact with based on an evaluation result of the third agent.

An information processing system according to a sixth aspect of the present disclosure is the information processing system according to the first aspect, wherein the processor causes the first agent to autonomously execute negotiations using the output of the trained model during the dialogue with the second agents, based on the user request or answers from other second agents.

An information processing system according to a seventh aspect of the present disclosure is the information processing system according to the sixth aspect, wherein the processor causes the user to confirm a result of the negotiation between the first agent and the second agent, and causes the first agent to interact with the second agent based on a result of the confirmation by the user.

An information processing system according to an eighth aspect of the present disclosure is the information processing system according to the sixth aspect or the seventh aspect, wherein the negotiation is a negotiation regarding price or condition.

An information processing method according to a ninth aspect of the present disclosure executes a process in which a processor causes: a first agent to interpret a user request using a trained model; the first agent to autonomously execute parallel dialogues based on the user request with a plurality of second agents using an output of the trained model; and the first agent to aggregate information obtained by the dialogues with the second agents and provide the aggregated information to the user using the output of the trained model.

A non-transitory recording medium storing an information processing program according to a tenth aspect of the present disclosure causes a computer to execute a process of: causing a first agent to interpret a user request using a trained model; causing the first agent to autonomously execute parallel dialogues based on the user request with a plurality of second agents using an output of the trained model; and causing the first agent to aggregate information obtained by the dialogues with the second agents and provide the aggregated information to the user using the output of the trained model.

According to the present disclosure, it is possible to provide an information processing system, an information processing method, and a non-transitory recording medium that efficiently provide a user with information provided from a plurality of agents as compared with a case where the user individually makes inquiries to the agents.

### BRIEF DESCRIPTION OF THE DRAWINGS

Exemplary embodiments of the present disclosure will be described in detail based on the following figures, wherein:

FIG. 1 is a diagram illustrating a schematic configuration of a data processing system according to an embodiment of the disclosed technology.

FIG. 2 is a diagram illustrating an example of a configuration of the data processing system according to the embodiment of the disclosed technology.

FIG. 3 is a diagram illustrating an example of main functions of a data processing device and a smart device.

FIG. 4A is a diagram explaining processing of a specific processing unit.

FIG. 4B is a diagram explaining processing of the specific processing unit.

FIG. 4C is a diagram explaining processing of the specific processing unit.

FIG. 4D is a diagram explaining processing of the specific processing unit.

FIG. 4E is a diagram explaining processing of the specific processing unit.

FIG. 4F is a diagram explaining processing of the specific processing unit.

FIG. 5 is a diagram illustrating a functional configuration example of the specific processing unit.

FIG. 6 is a diagram illustrating an example of a flow of a specific process executed by the data processing device.

### DETAILED DESCRIPTION OF THE INVENTION

Hereinafter, an example of an embodiment of the present disclosure will be described with reference to the drawings. In each drawing, the same or equivalent components and parts are denoted by the same reference numerals. In addition, dimensional ratios in the drawings are exaggerated for convenience of description and may differ from actual ratios.

### First, terms used in the following description will be described

In the following embodiments, a processor with a reference numeral (hereinafter simply referred to as a "processor") may be a single arithmetic unit or a combination of a plurality of arithmetic units. Further, the processor may be one type of arithmetic unit or a combination of a plurality of types of arithmetic units. Examples of the arithmetic unit include a CPU (Central Processing Unit), a GPU (Graphics Processing Unit), a GPGPU (General-Purpose computing on Graphics Processing Units), an APU (Accelerated Processing Unit), and the like.

In the following embodiments, a RAM (Random Access Memory) with a reference numeral is a memory in which information is temporarily stored, and is used as a work memory by the processor.

In the following embodiments, a storage with a reference numeral is one or a plurality of non-volatile storage devices storing various programs, various parameters, and the like. Examples of the non-volatile storage device include a flash memory (SSD (Solid State Drive)), a magnetic disk (for example, a hard disk), a magnetic tape, and the like.

In the following embodiments, a communication I/F (Interface) with a reference numeral is an interface including a communication processor, an antenna, and the like. The communication I/F controls communication between a plurality of computers. Examples of communication standards applied to the communication I/F include wireless communication standards including 5G (5th Generation Mobile Communication System), Wi-Fi (registered trademark), Bluetooth (registered trademark), and the like.

In the following embodiments, "A and/or B" is synonymous with "at least one of A and B". That is, "A and/or B" means that it may be A alone, B alone, or a combination of A and B. In the present specification, the same concept as "A and/or B" is applied when three or more matters are expressed by connecting them with "and/or".

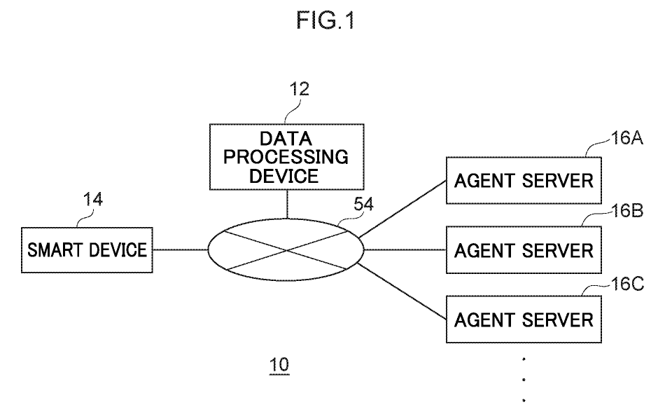

FIG. 1 is a diagram illustrating a schematic configuration of a data processing system 10 according to the present embodiment. As illustrated in FIG. 1, the data processing system 10 includes a data processing device 12 and a smart device 14. An example of the data processing device 12 is a server. An example of the smart device 14 is a smartphone. In the present embodiment, the data processing device 12 is an example of an "information processing system" according to the disclosed technology.

The data processing device 12 interprets a request from the smart device 14 sent through a network 54, and provides an agent for making inquiries through the network 54 to agents provided by agent servers 16A, 16B, ... based on the request from the smart device 14. The agent provided by the data processing device 12 is an example of a "first agent" according to the disclosed technology, and the agents provided by the agent servers 16A, 16B, ... are an example of a "second agent" according to the disclosed technology. The agents provided by the agent servers 16A, 16B, ... may also be referred to as "external agents" in the following description.

The agent provided by the data processing device 12 interprets the request from the smart device 14 using a data generation model 58. The agent provided by the data processing device 12 performs parallel dialogues based on the request from the smart device 14 with the agents provided by the agent servers 16A, 16B, ... using the data generation model 58. Then, the agent provided by the data processing device 12 aggregates answers from the external agents using the data generation model 58, and provides the aggregated answers to the smart device 14.

In the data processing system 10 according to the present embodiment, since the data processing device 12 provides the user's agent, information provided from a plurality of agents is aggregated, making it possible to efficiently provide information to the user of the smart device 14, as compared to a case where the smart device 14 individually makes inquiries to the external agents.

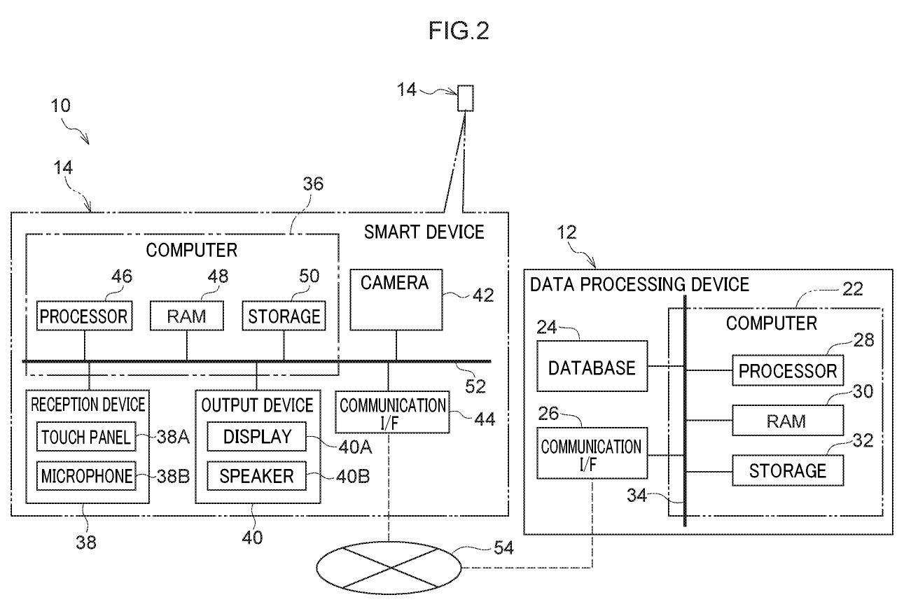

FIG. 2 illustrates an example of a configuration of the data processing system 10 according to the embodiment.

The data processing device 12 includes a computer 22, a database 24, and a communication I/F 26. The computer 22 is an example of a "computer" according to the disclosed technology. The computer 22 includes a processor 28, a RAM 30, and a storage 32. The processor 28, the RAM 30, and the storage 32 are connected to a bus 34. The database 24 and the communication I/F 26 are also connected to the bus 34. The communication I/F 26 is connected to the network 54. An example of the network 54 includes a WAN (Wide Area Network) and/or a LAN (Local Area Network).

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. The reception device 38, the output device 40, and the camera 42 are also connected to the bus 52.

The reception device 38 includes a touch panel 38A, a microphone 38B, and the like, and receives user input. The touch panel 38A receives user input by detecting contact of an indicator (for example, a pen or a finger). The microphone 38B receives user input by voice by detecting the user's voice. The control unit 46A transmits data indicating the user input received by the touch panel 38A and the microphone 38B to the data processing device 12. In the data processing device 12, a specific processing unit 290 acquires the data indicating the user input.

The output device 40 includes a display 40A, a speaker 40B, and the like, and presents data to the person 20 by outputting the data in a representational form perceivable by the person 20 (for example, voice and/or text). The display 40A displays visual information such as text and images in accordance with instructions from the processor 46. The speaker 40B outputs voice in accordance with instructions from the processor 46. The camera 42 is a small digital camera equipped with an optical system such as a lens, an aperture, and a shutter, and an imaging element such as a CMOS (Complementary Metal-Oxide-Semiconductor) image sensor or a CCD (Charge Coupled Device) image sensor.

The communication I/F 44 is connected to the network 54. The communication I/Fs 44 and 26 control transmission and reception of various types of information between the processor 46 and the processor 28 via the network 54.

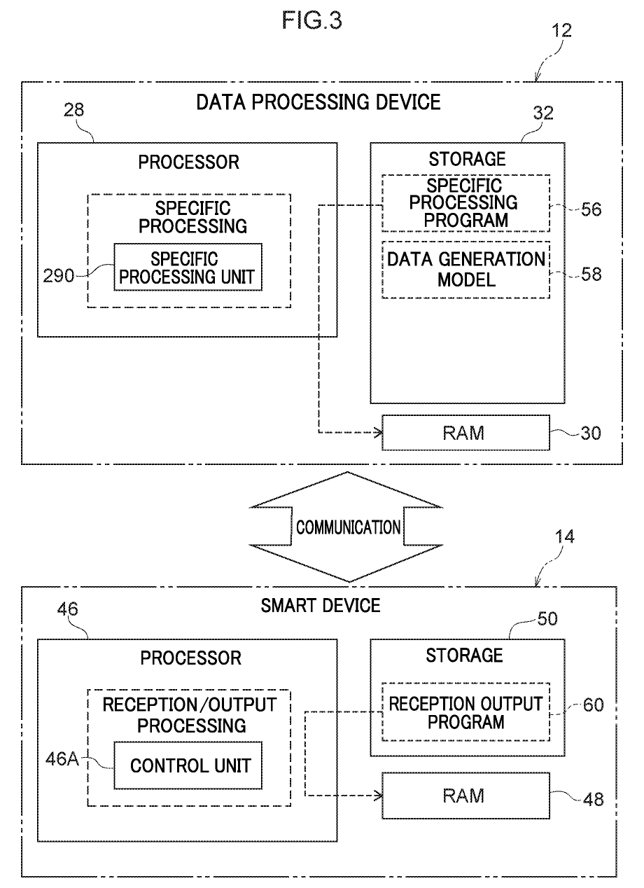

FIG. 3 illustrates an example of main functions of the data processing device 12 and the smart device 14.

As illustrated in FIG. 3, in the data processing device 12, specific processing is performed by the processor 28. A specific processing program 56 is stored in the storage 32. The specific processing program 56 is an example of an "information processing program" according to the disclosed technology. The processor 28 reads the specific processing program 56 from the storage 32, and executes the read specific processing program 56 on the RAM 30. The specific processing is realized by the processor 28 operating as the specific processing unit 290 in accordance with the specific processing program 56 executed on the RAM 30.

The storage 32 stores a data generation model 58. The data generation model 58 is used by the specific processing unit 290.

The data generation model 58 is a so-called generative AI (Artificial Intelligence). Examples of the data generation model 58 include generative AIs such as ChatGPT (Internet search <URL: https://openai.com/blog/chatgpt>) and Gemini (Internet search <URL: https://gemini.google.com/?hl=ja>). The data generation model 58 is obtained by causing a neural network to perform deep learning. A prompt including an instruction is input to the data generation model 58, and inference data such as voice data indicating voice, text data indicating text, and image data indicating an image is input thereto. The data generation model 58 infers the input inference data in accordance with the instruction indicated by the prompt, and outputs the inference result in a data format such as voice data and text data. Here, the inference refers to, for example, analysis, classification, prediction, and/or summarization. Note that, in the above-described example, the configuration in which the data generation model 58 is stored only in the data processing device 12 has been described, but the present disclosure is not limited thereto. For example, all or a part of the data generation model 58 may be distributed and stored in the smart device 14. In this case, before the smart device 14 transmits the user request to the data processing device 12, the smart device 14 side may execute partial interpretation processing of the user request as pre-processing, and transmit the pre-processed information to the data processing device 12. This makes it possible to achieve effects such as a reduction in the communication load on the network 54, an improvement in processing speed, and an improvement in the confidentiality of user data.

In the smart device 14, reception/output processing is performed by the processor 46. A reception/output program 62 is stored in the storage 50. The reception/output program 62 is used together with the specific processing program 56 by the data processing system 10. The processor 46 reads the reception/output program 62 from the storage 50, and executes the read reception/output program 62 on the RAM 48. The reception/output processing is realized by the processor 46 operating as a control unit 46A in accordance with the reception/output program 62 executed on the RAM 48.

Next, processing of the specific processing unit 290 when the data processing device 12 makes an inquiry to the external agent based on the request from the smart device 14 using the data generation model 58, and performs specific processing of aggregating answers from the external agent using the data generation model 58 and providing the aggregated answers to the smart device 14 will be described.

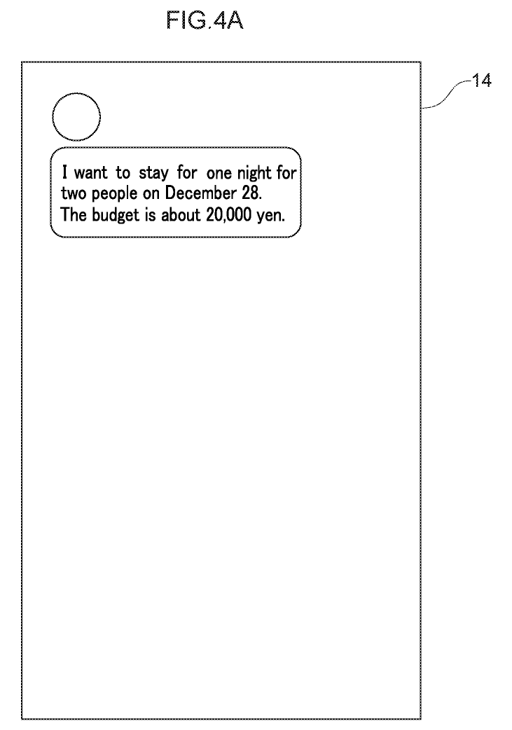

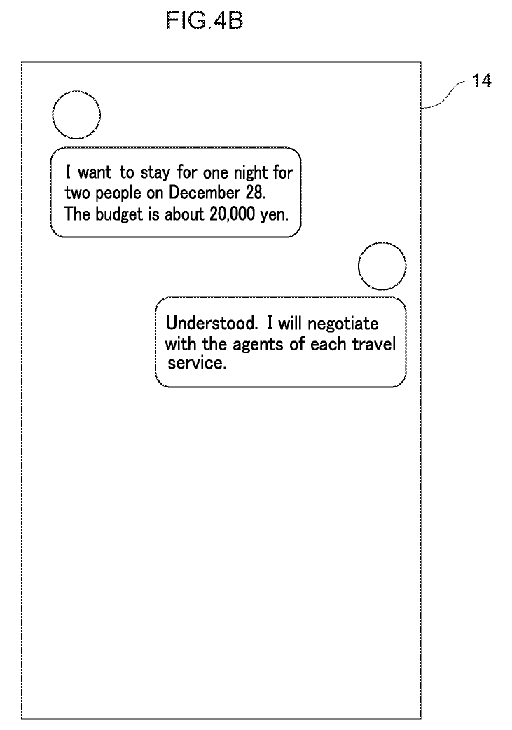

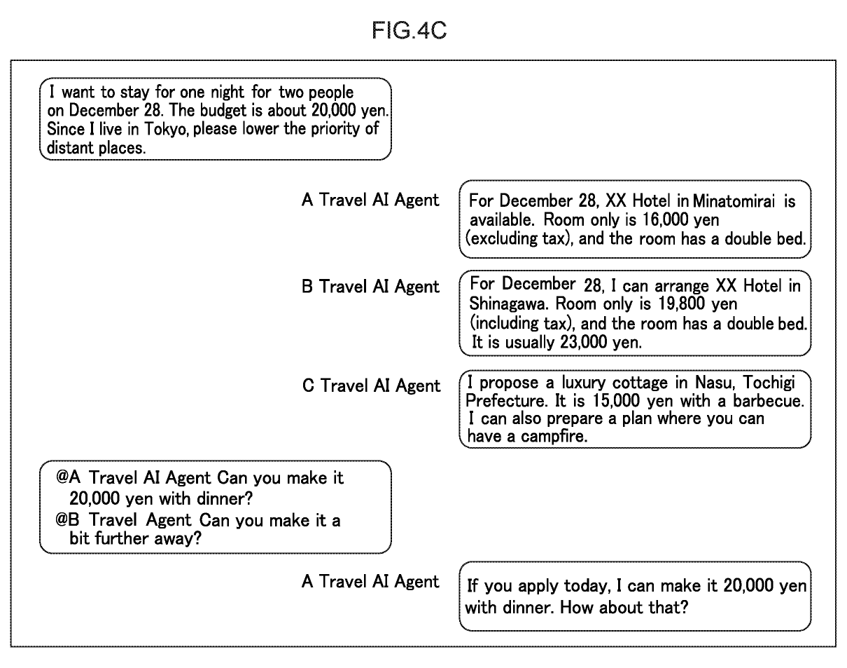

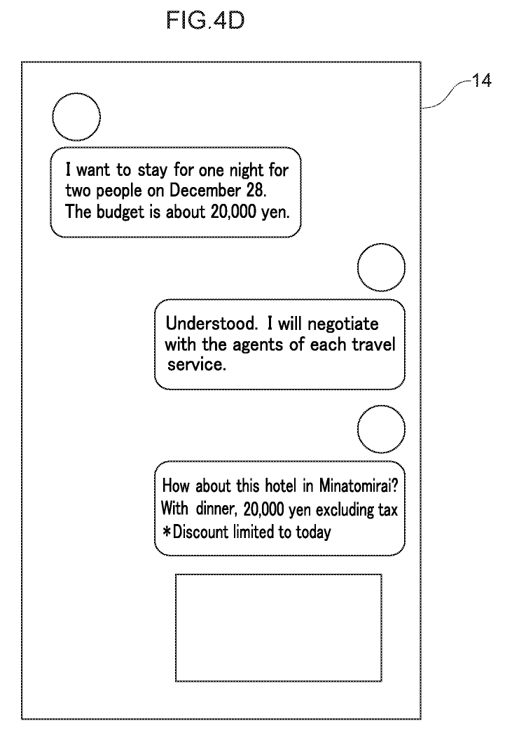

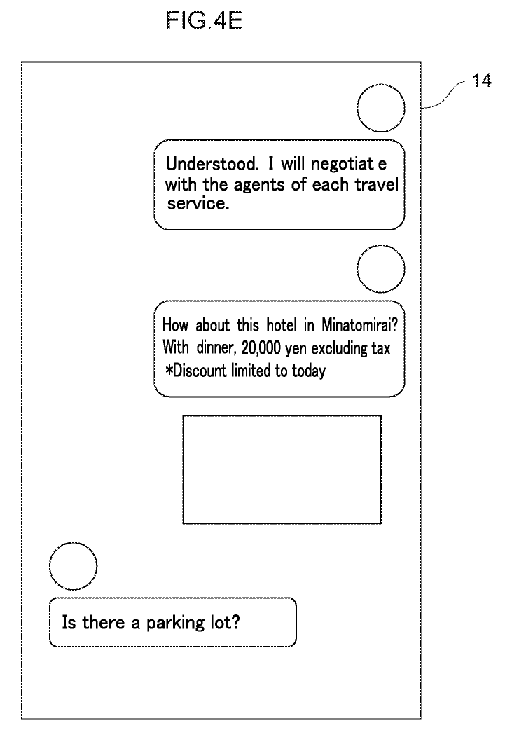

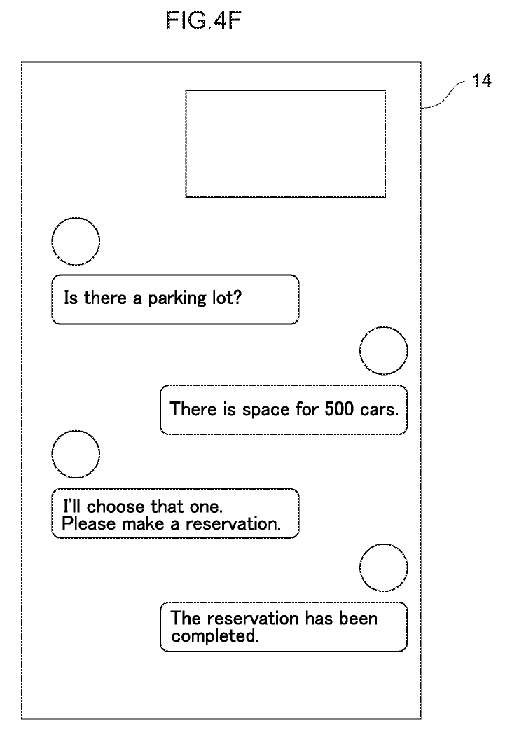

In the specific processing according to the present embodiment, as illustrated in FIG. 4A, when the user makes an arbitrary request using the smart device 14, the specific processing unit 290 interprets the request from the user. Then, based on the request from the user, the specific processing unit 290 makes an inquiry to the agents provided by the agent servers 16A, 16B, ... as the user's agent. In the example of FIG. 4A, since the user makes a request saying "I want to stay for one night for two people on December 28. The budget is about 20,000 yen," the specific processing unit 290 interprets the request and makes an inquiry to an agent provided by a hotel accommodation reservation service for a hotel that satisfies the user request, acting as the user's agent.

As illustrated in FIG. 4B, the specific processing unit 290, acting as the user's agent, executes a dialogue with the agent provided by the hotel accommodation reservation service using the data generation model 58. Here, if the user consents to providing the user's personal information, as illustrated in FIG. 4B, the specific processing unit 290 executes the dialogue by including, for example, the user's residence in the inquiry. As illustrated in FIG. 4B, the agent provided by the hotel accommodation reservation service proposes to the user's agent a hotel that seems to meet the user request.

When answers from the agent provided by the hotel accommodation reservation service have been acquired, the specific processing unit 290 autonomously negotiates with the agent provided by the hotel accommodation reservation service as the user's agent, as illustrated in FIG. 4C. In the example of FIG. 4C, a state is shown in which a price reduction negotiation is performed for the answer proposed by the agent A, and the agent A replies. Note that the exchanges shown in FIGS. 4B and 4C are not actually seen by the user.

Then, as illustrated in FIG. 4D, the specific processing unit 290, as the user's agent, presents the result of the dialogue with the agent provided by the hotel accommodation reservation service to the smart device 14. As illustrated in FIG. 4E, the user may ask additional questions about the presented content using the smart device 14. In the example of FIG. 4E, the user is asking about the availability of a parking lot. In this case, the specific processing unit 290, as the user's agent, inquires of the agent provided by the hotel accommodation reservation service or an agent provided by the hotel in question, using the output of the data generation model 58 based on the additional question input by the user. The reason why the specific processing unit 290 inquires of the agent provided by the hotel is that the agent provided by the hotel accommodation reservation service may not be able to provide information on the hotel's facilities.

The specific processing unit 290, as the user's agent, presents the result of the user's additional question to the smart device 14, as illustrated in FIG. 4F. In the example of FIG. 4F, it is presented to the smart device 14 that the hotel has 500 parking spaces. Further, FIG. 4F illustrates an example in which the user uses the smart device 14 to instruct a reservation for the presented hotel. The specific processing unit 290, as the user's agent, executes the reservation for the hotel presented to the user with the agent provided by the hotel accommodation reservation service. Here, if the user consents to providing the user's personal information, the specific processing unit 290 provides personal information such as the user's name, address, and telephone number to the agent provided by the hotel accommodation reservation service when making a hotel reservation.

By operating as the user's agent in this manner, the specific processing unit 290 can efficiently provide the user with information provided from a plurality of agents, as compared to a case where each user directly makes an inquiry to an agent provided by each service.

The specific processing unit 290 may be provided with a dynamic management function of the consent status that allows the user him/herself to change the consent contents of the data sharing once given by the user at any time. Specifically, the user may be allowed to change the sharing settings for each agent or each provided data item on the smart device 14, and data provided during a dialogue with an external agent may be dynamically controlled based on the changed consent content. With such a function, flexibility in the user's privacy management is increased, and the user's convenience and sense of security can be improved.

When having a dialogue with an external agent, the specific processing unit 290, as the user's agent, may autonomously negotiate with the external agent using the output of the data generation model 58. For example, when a hotel accommodation fee is presented by an external agent, the specific processing unit 290 may, as a user's agent, autonomously negotiate with the external agent using the output of the data generation model 58 to see if the accommodation fee can be lowered, or if a higher grade room can be prepared for the same fee. The specific processing unit 290 may output a result of the autonomous negotiation with the external agent to the smart device 14, and cause the user to confirm the negotiation result. Then, the specific processing unit 290 may execute the autonomous dialogue with the external agent as the user's agent based on the user's confirmation result of the negotiation result. The specific processing unit 290 performs autonomous negotiation using the output of the data generation model 58, thereby making it possible to draw more favorable conditions from the external agent. Further, the specific processing unit 290 may evaluate the negotiation with the external agent not only from the viewpoint of price but also from a plurality of viewpoints such as time, service quality, options, and cancellation policy, and may autonomously negotiate using the data generation model 58 so as to comprehensively obtain an optimal negotiation result. In the autonomous negotiation, when an answer satisfying preset target conditions (for example, a fee within a budget range specified by the user, a specific service option, etc.) is obtained, or when the number of negotiations reaches a predetermined number of times (for example, 3 times), the specific processing unit 290 may stop the negotiation processing and present the optimal negotiation result obtained up to that point to the user. For example, regarding a hotel reservation, the specific processing unit 290 may evaluate a plurality of conditions such as check-in time, check-out time, possibility of room upgrade, presence or absence of a cancellation fee, free breakfast and parking lot provision comprehensively in addition to the accommodation fee, and may conduct negotiations to extract the most favorable conditions for the user from the external agent.

Furthermore, rather than ending the negotiation with the external agent in a single session, the specific processing unit 290 may autonomously repeat the negotiation a plurality of times (multi-round negotiation) until conditions satisfying the user request (for example, upper limit of budget, desired date and time, specific service quality, etc.) are reached, or until the maximum number of negotiations set in advance by the user (for example, 5 times) is reached. When the user request is not satisfied even after the predetermined number of times is reached, the specific processing unit 290 may notify the user that an answer satisfying the request could not be obtained, and propose a next-best measure (for example, relaxation of conditions, inquiries to other agents, etc.). For example, in negotiations related to hotel reservations, the specific processing unit 290 may repeatedly conduct additional negotiations requesting price and condition adjustments again for the fee and service contents presented in the initial negotiation, gradually drawing out optimal conditions for the user. With this multi-round negotiation function, the user can obtain more flexible and favorable conditions, increasing the possibility of reaching an agreement with the service provider side.

As a result of the autonomous negotiation with the external agent, the specific processing unit 290 may be completely unable to obtain an answer that satisfies the user request. For example, when the user makes the above-described request, it is possible that a hotel where the user can stay for 20,000 yen on December 28 cannot be found no matter what. When an answer satisfying the user's requirement conditions (for example, within a budget of 20,000 yen) is not obtained, the specific processing unit 290 may propose raising the upper limit amount to the user, and output the allowable range to the smart device 14 for confirmation. In addition, when the user does not desire an increase in the upper limit amount, the specific processing unit 290 may propose an alternative plan such as a schedule change, relaxation of the facility grade or conditions, or a choice of a facility in another region. If a new upper limit is input from the user, the specific processing unit 290 may execute autonomous dialogue with the external agent using the new upper limit.

The specific processing unit 290 may accumulate the usage tendency of the user from autonomous dialogues with external agents, and may determine the content of an inquiry to an external agent based on the usage tendency. The specific processing unit 290 may determine the content of an inquiry to the external agent using the usage tendency of dialogues of users having similar attributes. For example, the specific processing unit 290 may accumulate trends in areas and budgets when users make hotel reservations, trends in flight ticket reservation timing, desired seat classes, and the like, and may automatically determine conditions and priorities to be inquired to the external agent when the user newly makes a travel plan based on these trends. Also, the specific processing unit 290 may predict services and facilities that the user has not experienced but is likely to be interested in based on the usage trends of other users with similar age groups and preferences, and may inquire of an external agent to actively propose them to the user.

The specific processing unit 290 may receive a user request in advance from the smart device 14, and output the aggregated answer to the smart device 14 at a timing when an answer satisfying the user request is obtained from the external agent. For example, suppose a request from the user saying "Tell me when the flight ticket from Haneda to Naha on August 1st drops below 20,000 yen" is sent from the smart device 14. In this case, the specific processing unit 290 may have a dialogue with an external agent operated by an airline company or a travel agency so as to notify the timing when the flight ticket from Haneda to Naha on August 1 drops below 20,000 yen. As a result, the specific processing unit 290 can notify the smart device 14 at the timing when the flight ticket from Haneda to Naha on August 1 drops below 20,000 yen.

The specific processing unit 290 may perform an autonomous dialogue with an external agent by using the user's action data accumulated in the smart device 14, instead of or in addition to an explicit request from the user from the smart device 14. Furthermore, based on past accumulated user request histories, purchase histories, preference information, or user behavioral histories recorded on the smart device 14, the specific processing unit 290 may predict information that the user might be interested in before the user inputs an explicit request, and autonomously execute inquiries to external agents. By using such a predictive proposal function, it is possible to eliminate the time and effort for the user to explicitly input his/her request, improving the user experience. For example, for users who participate in the same event or travel at the same time every year, information regarding the event or travel plan can be queried in advance prior to that period, and presented or push-notified to the user at an appropriate timing.

The specific processing unit 290 may dynamically take in not only the user's behavioral history and request history, but also external environmental information such as the user's life rhythm, seasonal factors, social event information, as well as weather changes and disaster information, and comprehensively analyze and predict this information with the data generation model 58 to make optimal proposals at appropriate timings. For example, the specific processing unit 290 may make fine-tuned proposals tailored to the situation, such as proposing a reservation change or recommending a cancellation insurance subscription in advance when a typhoon approaches, to a user who has experience booking flight tickets or hotels during the typhoon season in the past. Through such an advanced predictive proposal function, users can avoid unexpected risks in advance, further improving convenience and user satisfaction.

The specific processing unit 290 may also make a proposal not to a specific user but to a group including users such as family members, using the result of autonomous dialogue with an external agent. For example, when a user plans a family trip, the specific processing unit 290 may autonomously communicate with external agents providing various travel services in consideration of each family member's schedule, past travel history, preferences, budget constraints, etc., and propose an optimal travel plan for all family members. Furthermore, the specific processing unit 290 may make proposals that improve the convenience of the group, such as making a reservation for a restaurant that satisfies the common preferences of all family members, or purchasing tickets to an event that can be shared by a plurality of users.

In FIGS. 4A-4F, an example is shown of a case where a user tries to reserve a hotel, but the application of this system is not limited to such an example. This system can be applied to various situations such as purchasing merchandise, insurance estimates, moving estimates, and assessments when selling merchandise such as an automobile. For example, this system may be used when the user intends to purchase merchandise. For example, when the user wants to purchase limited-edition ice cream, the specific processing unit 290, as the user's agent, inquires about the inventory of the ice cream to an agent provided by a convenience store, and presents to the smart device 14 information on the inventory of convenience store shops that have the inventory of the ice cream. At this time, when information on the current position of the user is available, the specific processing unit 290 may present to the smart device 14 inventory information of convenience store shops close to the user's current position.

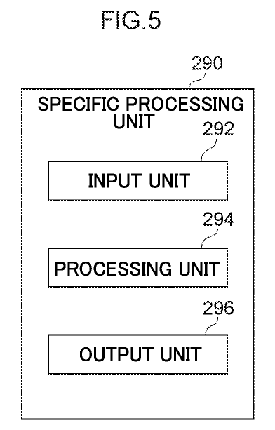

As illustrated in FIG. 5, the specific processing unit 290 includes an input unit 292, a processing unit 294, and an output unit 296.

The input unit 292 acquires the user input received by the smart device 14. Specifically, data of at least one of text, voice, and image input by the user received by the smart device 14 is acquired. In the present embodiment, the input unit 292 acquires a request from the user to the user's agent.

The processing unit 294 performs specific processing using the data generation model 58. Specifically, character data, audio data, and image data input by the user are input to the data generation model 58 to obtain a generation result. Moreover, based on the generation result, a result of the inquiry to the external agent based on the user request is generated, and answers from the external agent are aggregated.

For example, when the user requests "I want to stay for one night for two people on December 28. The budget is about 20,000 yen," as described above, the processing unit 294 interprets the content of the request and determines to make an inquiry to an agent provided by a hotel accommodation reservation service. Then, the processing unit 294, acting as the user's agent, inquires of the agent provided by the hotel accommodation reservation service using the output of the data generation model 58 as to whether there are vacancies in hotels matching the user request.

When the processing unit 294 aggregates answers from the agents, if it acquires answers that match the user request from a plurality of agents, it may use one or more answers close to the user request among them to aggregate the answers. For example, in the case of the above-described hotel example, when there are a plurality of hotel vacancies within the budget range requested by the user, the processing unit 294 may aggregate the information on the plurality of hotels, may aggregate only the information on the hotel with the lowest fee, or may aggregate only the information on the hotel farthest from the user's residence.

When making inquiries to external agents, the processing unit 294 may select external agents to be inquired based on the results of past inquiries. For example, the processing unit 294 may preferentially select an external agent that has given an answer matching the user request. The processing unit 294 may cause an evaluation agent to evaluate answers from the external agent to the user request using the generation model 58. The evaluation agent is an example of a "third agent" of the present disclosure. Then, the processing unit 294 may select the agent to make an inquiry based on the evaluation result of the answers by the evaluation agent. Also, the processing unit 294 may feed back the evaluation result of the answers by the evaluation agent to the external agent. Further, when the content of an answer provided by an external agent conflicts with or contradicts an answer from another external agent, the processing unit 294 may execute cross-validation using the data generation model 58. For example, when differences are found among agents regarding hotel facilities or service contents, the processing unit 294 may acquire additional information from another agent or the official website of the hotel to conduct validation, evaluate the accuracy and reliability of the information, and provide the user with the information determined to be most reliable. Thereby, the processing unit 294 can significantly improve the accuracy and reliability of the information presented to the user, as compared to a case where validation is not performed.

Furthermore, the evaluation agent may have the following functions in order to evaluate the answer contents obtained from the external agent. For example, the evaluation agent may use the data generation model 58 to accumulate history information such as the accuracy of answer contents provided to the same or similar inquiries in the past, response speed, and satisfaction feedback from users, and may evaluate the reliability and quality of answers of each external agent based on them. Also, the evaluation agent may collect information on the accuracy and recency of the answer contents subject to evaluation from a plurality of other information sources (for example, public databases, review sites, official websites, etc.) and perform a comparative verification with them. Consequently, the evaluation agent can quantitatively evaluate the reliability of answers obtained from each external agent, and ultimately improve the accuracy and reliability of information provided to the user.

The output unit 296 transmits the result of the specific processing to the smart device 14. In the smart device 14, the control unit 46A causes the output device 40 to output the result of the specific processing. The microphone 38B acquires voice indicating a user input for the result of the specific processing. The control unit 46A transmits the voice data indicating the user input acquired by the microphone 38B to the data processing device 12. In the data processing device 12, the specific processing unit 290 acquires the voice data. In the present embodiment, the output unit 296 transmits to the smart device 14 the result of inquiring to the external agent based on the user request.

### Next, the operation of the data processing system 10 will be described

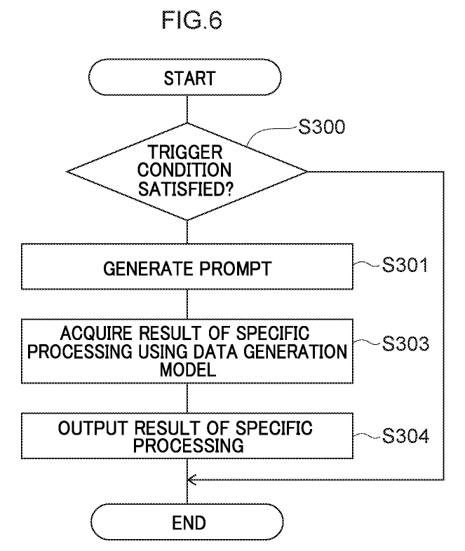

An example of the flow of the specific processing will be described with reference to FIG. 6. The flow of specific processing illustrated in FIG. 6 is an example of an "information processing method" according to the disclosed technology.

In step S300, the processing unit 294 determines whether or not a predetermined trigger condition is satisfied. Here, the "predetermined trigger condition" in the present embodiment means that a request from the user has been transmitted from the smart device 14. The user request includes, as described above, hotel accommodation, product purchase, and the like.

In step S300, when the trigger condition is satisfied (step S300; Yes), the data processing system 10 proceeds to step S301. On the other hand, in step S300, when the trigger condition is not satisfied (step S300; No), the data processing system 10 ends the specific processing.

In step S301, the processing unit 294 generates a prompt by adding an instruction sentence for obtaining the result of the specific processing to the text representing the input. Specifically, the processing unit 294 generates a prompt for interpreting a user request transmitted from the smart device 14 and generates a prompt for making an inquiry to an external agent based on the user request.

In step S303, the processing unit 294 inputs the generated prompt to the data generation model 58, and acquires the result of the specific processing based on the output of the data generation model 58. Specifically, the processing unit 294 acquires a result of interpreting the user request transmitted from the smart device 14 by the data generation model 58. Further, the processing unit 294 acquires and aggregates results of making inquiries to the external agents based on the output of the data generation model 58.

In step S304, the output unit 296 outputs the result of the specific processing to the smart device 14, and ends the specific processing. Specifically, the output unit 296 outputs a result of aggregating answers from the external agents to the smart device 14.

Although the system according to the present disclosure has been described primarily focusing on the functions of the data processing device 12, the system according to the present disclosure is not necessarily implemented on a server. The system according to the present disclosure may be implemented as a general information processing system. The present disclosure may be implemented as, for example, a software program operating on a personal computer, an application operating on a smartphone, or the like. The method according to the present disclosure may be provided to the user in a SaaS (Software as a Service) format.

In the above embodiment, an example in which the specific processing is performed by one computer 22 has been described, but the technology of the present disclosure is not limited thereto, and distributed processing for specific processing by a plurality of computers including the computer 22 may be performed.

In the above embodiment, an example in which the specific processing program 56 is stored in the storage 32 has been described, but the technology of the present disclosure is not limited thereto. For example, the specific processing program 56 may be stored in a portable computer-readable non-transitory storage medium such as a USB (Universal Serial Bus) memory. The specific processing program 56 stored in the non-transitory storage medium is installed in the computer 22 of the data processing device 12. The processor 28 executes specific processing according to the specific processing program 56.

Alternatively, the specific processing program 56 may be stored in a storage device such as a server connected to the data processing device 12 via the network 54, and the specific processing program 56 may be downloaded and installed in the computer 22 in response to a request from the data processing device 12.

Note that it is not necessary to store the entire specific processing program 56 in a storage device such as a server connected to the data processing device 12 via the network 54, or to store the entire specific processing program 56 in the storage 32, and a part of the specific processing program 56 may be stored.

As hardware resources for executing specific processing, the following various processors can be used. Examples of the processor include a CPU, which is a general-purpose processor that functions as a hardware resource executing specific processing by executing software, that is, a program. Further, examples of the processor include a dedicated electric circuit which is a processor having a circuit configuration specially designed for executing specific processing, such as an FPGA (Field-Programmable Gate Array), a PLD (Programmable Logic Device), or an ASIC (Application Specific Integrated Circuit). A memory is built in or connected to any processor, and any processor executes specific processing by using the memory.

The hardware resource executing specific processing may be configured by one of these various processors, or may be configured by a combination of two or more processors of the same type or different types (for example, a combination of a plurality of FPGAs, or a combination of a CPU and an FPGA). The hardware resource executing specific processing may be a single processor.

As an example configured with a single processor, firstly, there is a form in which one processor is configured with a combination of one or more CPUs and software, and this processor functions as a hardware resource executing specific processing. Secondly, there is a form in which a processor realizing the functions of the entire system including a plurality of hardware resources executing specific processing with a single IC chip is used, as represented by SoC (System-on-a-chip) or the like. In this way, specific processing is realized using one or more of the above various processors as hardware resources.

Furthermore, as a hardware structure of these various processors, more specifically, an electric circuit combining circuit elements such as semiconductor elements can be used. The specific processing described above is merely an example. Therefore, it goes without saying that unnecessary steps may be deleted, new steps may be added, and the processing order may be changed without departing from the gist.

The contents described and illustrated above are detailed descriptions of portions pertaining to the technology of the present disclosure, and are merely examples of the technology of the present disclosure. For example, the descriptions regarding the configurations, functions, operations, and effects above are examples of the configurations, functions, operations, and effects of the portions pertaining to the technology of the present disclosure. Therefore, it goes without saying that unnecessary portions may be deleted, new elements may be added, or replacements may be made to the above-described and illustrated contents without departing from the spirit of the technology of the present disclosure. Furthermore, to avoid confusion and facilitate understanding of the parts relating to the technology of the present disclosure, explanations of common technical knowledge and the like that do not particularly require explanation to enable the implementation of the technology of the present disclosure are omitted in the descriptions and drawings shown above.

In addition, the effects described in the above embodiments are descriptive or exemplary, and are not limited to those described in the above embodiments. That is, the technology according to the present disclosure can exhibit other effects apparent to those with ordinary knowledge in the technical field of the present disclosure from the description in the above embodiments, in addition to or instead of the effects described in the above embodiments.

All documents, patent applications, and technical standards mentioned in this specification are incorporated herein by reference to the same extent as if each individual document, patent application, and technical standard was specifically and individually indicated to be incorporated by reference.

### Regarding the above embodiments, the following are further disclosed

(Appendix 1) An information processing system comprising a processor, wherein the processor executes a process of: causing a first agent to interpret a user request using a trained model; causing the first agent to autonomously execute parallel dialogues based on the user request with a plurality of second agents using an output of the trained model; and causing the first agent to aggregate information obtained through the dialogues with the second agents, and provide the aggregated information to the user using the output of the trained model.

(Appendix 2) The information processing system according to appendix 1, wherein the processor causes the first agent to enable sharing of the user's data among the second agents based on the user's consent.

(Appendix 3) The information processing system according to appendix 1 or 2, wherein the processor causes the first agent to provide information to the user using the output of the trained model at a timing when new information is provided from the second agents.

(Appendix 4) The information processing system according to any one of appendices 1 to 3, wherein the processor causes a third agent to evaluate answers of the second agents using the output of the trained model.

(Appendix 5) The information processing system according to appendix 4, wherein the processor causes the first agent to select the second agent to interact with based on an evaluation result of the third agent.

(Appendix 6) The information processing system according to any one of appendices 1 to 5, wherein the processor causes the first agent to autonomously execute negotiations using the output of the trained model during the dialogue with the second agents, based on the user request or answers from other second agents.

(Appendix 7) The information processing system according to appendix 6, wherein the processor causes the user to confirm a result of the negotiation between the first agent and the second agent, and causes the first agent to interact with the second agent based on a result of the confirmation by the user.

(Appendix 8) The information processing system according to appendix 6 or 7, wherein the negotiation is a negotiation regarding price or condition.

(Appendix 9) An information processing method wherein a processor executes a process of: causing a first agent to interpret a user request using a trained model; causing the first agent to autonomously execute dialogues based on the user request with a plurality of second agents using an output of the trained model; and causing the first agent to aggregate information obtained by the dialogues with the second agents and provide the aggregated information to the user using the output of the trained model.

(Appendix 10) A non-transitory recording medium storing an information processing program that causes a computer to execute a process of: causing a first agent to interpret a user request using a trained model; causing the first agent to autonomously execute dialogues based on the user request with a plurality of second agents using an output of the trained model; and causing the first agent to aggregate information obtained by the dialogues with the second agents and provide the aggregated information to the user using the output of the trained model.

What is claimed is:

1. An information processing system comprising a processor, wherein the processor executes a process of:
causing a first agent to interpret a user request using a trained model;
causing the first agent to autonomously execute parallel dialogues based on the user request with a plurality of second agents using an output of the trained model; and
causing the first agent to aggregate information obtained through the dialogues with the second agents, and provide the aggregated information to the user using the output of the trained model.

2. The information processing system according to claim 1, wherein the processor causes the first agent to enable sharing of the user's data among the second agents based on the user's consent.

3. The information processing system according to claim 1, wherein the processor causes the first agent to provide information to the user using the output of the trained model at a timing when new information is provided from the second agents.

4. The information processing system according to claim 1, wherein the processor causes a third agent to evaluate answers of the second agents using the output of the trained model.

5. The information processing system according to claim 4, wherein the processor causes the first agent to select the second agent to interact with based on an evaluation result of the third agent.

6. The information processing system according to claim 1, wherein the processor causes the first agent to autonomously execute negotiations using the output of the trained model during the dialogue with the second agents, based on the user request or answers from other second agents.

7. The information processing system according to claim 6, wherein the processor causes the user to confirm a result of the negotiation between the first agent and the second agent, and causes the first agent to interact with the second agent based on a result of the confirmation by the user.

8. The information processing system according to claim 6, wherein the negotiation is a negotiation regarding price or condition.

9. An information processing method wherein a processor executes a process of:
causing a first agent to interpret a user request using a trained model;
causing the first agent to autonomously execute parallel dialogues based on the user request with a plurality of second agents using an output of the trained model; and
causing the first agent to aggregate information obtained by the dialogues with the second agents and provide the aggregated information to the user using the output of the trained model.

10. A non-transitory recording medium storing an information processing program that causes a computer to execute a process of:
causing a first agent to interpret a user request using a trained model;
causing the first agent to autonomously execute parallel dialogues based on the user request with a plurality of second agents using an output of the trained model; and
causing the first agent to aggregate information obtained by the dialogues with the second agents and provide the aggregated information to the user using the output of the trained model.
